(19) United States
(12) Patent Application Publication
(10) Pub. No.: US 2015/0152000 A1
(43) Pub. Date: Jun. 4, 2015

(54) SLUDGE DRYING SYSTEM

(71) Applicant: Byeong Yun PARK, Seoul (KR)

(72) Inventor: Byeong Yun PARK, Seoul (KR)

(21) Appl. No.: 14/093,281

(22) Filed: Nov. 29, 2013

(51) Int. Cl. C02F 11/14; C02F 11/12

(52) U.S. Cl. CPC C02F 11/14; C02F 11/127

(57) ABSTRACT

Disclosed therein is a sludge drying system which dries organic sludge generated in industrial sites or domestic sewage treatment plants by mixing the sludge with heat transfer oil, thereby contributing to improvement of drying efficiency. The sludge drying system includes: a preprocessing part including a sludge supplying part, a transfer oil storage tank, a recoverable oil storage tank, and a preheating and mixing tank; a drying part including first to fourth drying parts respectively having first to fourth vacuum drying pipes, and first to fourth liquid-vapor separators and first to fourth condensers, and a controlling part having first and second vacuum drying control pipes, fifth and sixth liquid-vapor separators and fifth and sixth condensers; and a post-processing part having a feeding tank, a centrifugal oil extractor, and a dried sludge storage tank.

### BACKGROUND OF THE INVENTION

1. Field of the Invention

The present invention relates to a sludge drying system, and more particularly, to a sludge drying system which dries organic sludge generated in industrial sites or domestic sewage treatment plants by mixing the sludge with heat transfer oil, thereby contributing to improvement of drying efficiency.

2. Background Art

In general, sludge generated in sewage treatment plants is treated in order of landfill, ocean dumping, agricultural usage, incineration, and others.

Out of the sludge treatment methods, the landfill occupied more than 70% of the whole sludge treatment methods, but has been prohibited by the direct landfilling prohibition law of organic sludge.

Moreover, out of the sludge treatment methods, the ocean dumping which was frequently used next the landfill was perfectly prohibited by laws related with waste treatment in 2012. Therefore, measures to treat and dispose sludge are urgently needed.

In the meantime, as a measure to treat the generated sludge, a method for producing fuel after drying sludge by vacuum drying in oil to use oil as heat transfer medium in a vacuum state is on the rise. In the sewage and sludge drying technology which has been used till now, an evaporator is heated at temperature higher than the boiling point of water in order to dry moisture contained in the sludge. Accordingly, the sewage and sludge drying technology has a problem in that outside water and free water of the sludge are only dried but inside water of the sludge is not dried because a sticky zone is formed due to a sudden temperature change of the sludge, and thus, it prevents a continuous sludge drying process and reduces durability life of the drying system. Finally, it deteriorates a sludge drying efficiency.

### SUMMARY OF THE INVENTION

Accordingly, the present invention has been made to solve the above-mentioned problems occurring in the prior arts, and it is an object of the present invention to provide a sludge drying system which dries organic sludge generated in industrial sites or domestic sewage treatment plants by mixing the sludge with heat transfer oil, thereby contributing to improvement of drying efficiency.

To accomplish the above object, according to the present invention, there is provided a sludge drying system including: a preprocessing part including a sludge supplying part, a transfer oil storage tank for storing transfer oil, a recoverable oil storage tank for recovering and storing transfer oil separated from the sludge, and a preheating and mixing tank; a drying part including a first drying part, a second drying part, a third drying part, a fourth drying part and a controlling part which are divided in a multi-stepwise manner, the first, second, third and fourth drying parts respectively including: first, second, third and fourth vacuum drying pipes for depressurizing the supplied sludge into a vacuum state; first, second, third and fourth liquid-vapor separators for separating moisture and gas discharged from the first, second, third and fourth vacuum drying pipes; and first, second, third and fourth condensers for condensing the separated moisture and gas, the controlling part including: first and second vacuum drying control pipes for receiving the sludge discharged from the first, second, third and fourth vacuum drying pipes and drying the received sludge in the vacuum state while stirring the sludge; fifth and sixth liquid-vapor separators for separating moisture and gas discharged from the first and second vacuum drying control pipes; and fifth and sixth condensers for condensing the separated moisture and gas; and a post-processing part including a feeding tank for collecting and supplying the sludge dried through the drying part; a centrifugal oil extractor for separating the transfer oil from the sludge supplied from the feeding tank by a centrifugal force; and a dried sludge storage tank for storing the dried sludge from which the transfer oil is separated.

As described above, the sludge drying system according to an exemplary embodiment of the present invention can prevent the sticky zone phenomenon by drying sludge at temperature lower than the boiling point of water in a multi-stepwise manner, and thus, facilitates a continuous drying process. The sludge drying system according to the exemplary embodiment of the present invention enables a rapid drying of sludge using a less energy than hot wind dry because it dries sludge by mixing transfer oil of a high heat transfer rate with the sludge, and thus, enhances a drying efficiency. Furthermore, the sludge drying system according to the exemplary embodiment of the present invention can enhance economic feasibility because reusing the sludge through separation and recovery after the drying process, and contribute to production of renewable energy through fuelization of the sludge. Additionally, the sludge drying system according to the exemplary embodiment of the present invention can contribute to eco-friendly environment through oxidation treatment and a remarkable reduction of sulfur content in a condensate water collecting facility and a gas collecting facility.

### BRIEF DESCRIPTION OF THE DRAWINGS

The above and other objects, features and advantages of the present invention will be apparent from the following detailed description of the preferred embodiment of the present invention in conjunction with the accompanying drawings, in which:

FIG. 1 is a process diagram showing an example of a sludge drying system according to an exemplary embodiment of the present invention;

FIG. 2 is a sectional view of vacuum drying pipes of the sludge drying system according to the exemplary embodiment of the present invention;

FIG. 3 is a perspective view showing the inside of the vacuum drying pipes of the sludge drying system according to the exemplary embodiment of the present invention;

FIG. 4 is a perspective view showing heating plates and stirring wings of the sludge drying system according to the exemplary embodiment of the present invention; and

FIG. 5 is a perspective view of the stirring wings of the sludge drying system according to the exemplary embodiment of the present invention.

### DETAILED DESCRIPTION OF THE PREFERRED EMBODIMENT

Reference will be now made in detail to the preferred embodiment of the present invention with reference to the attached drawings.

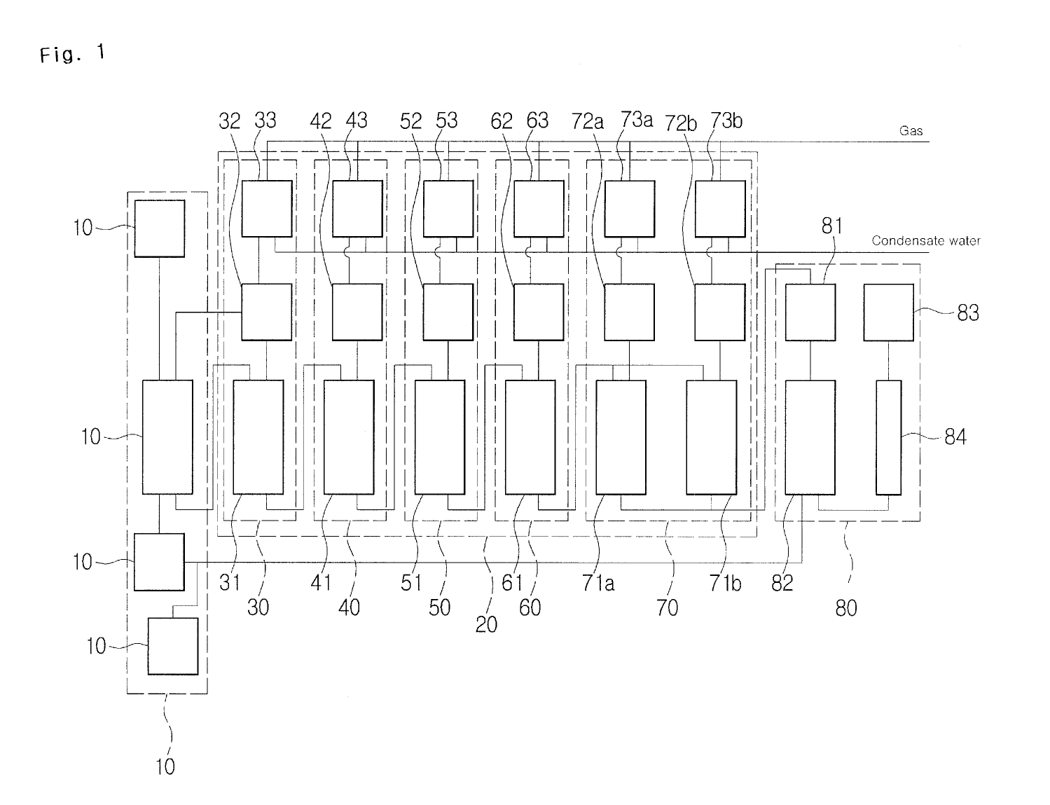

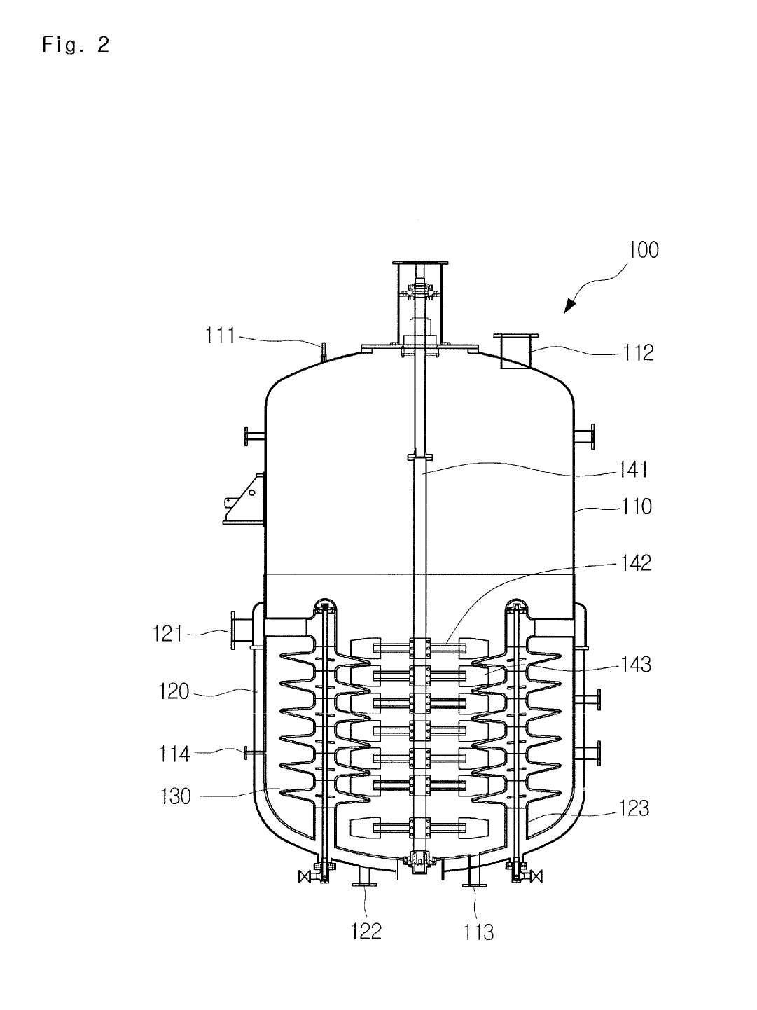

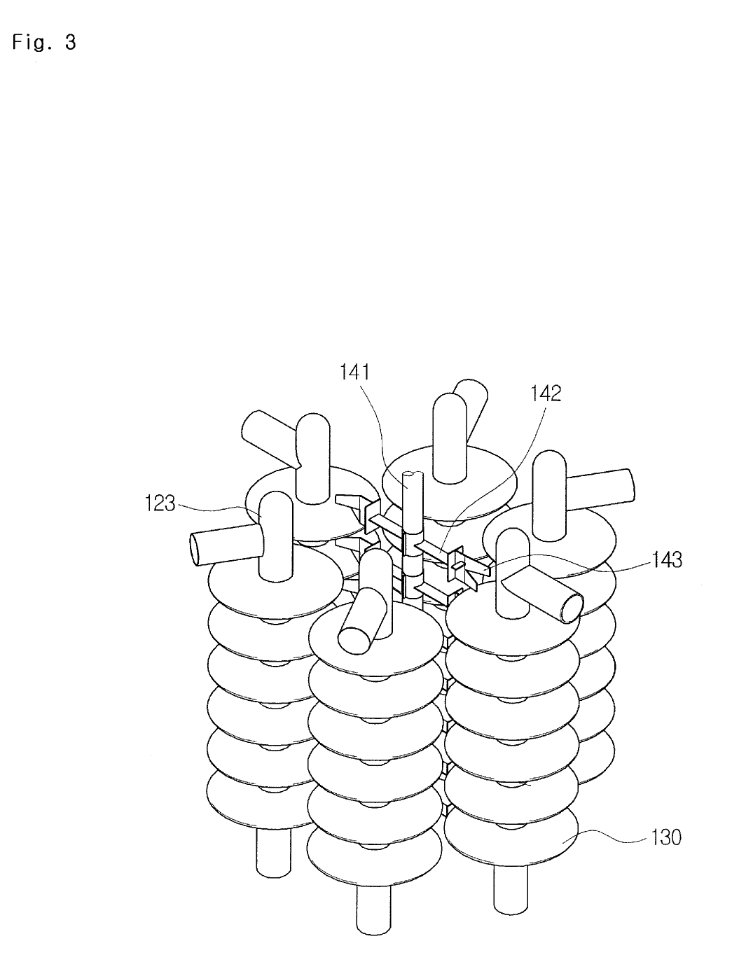

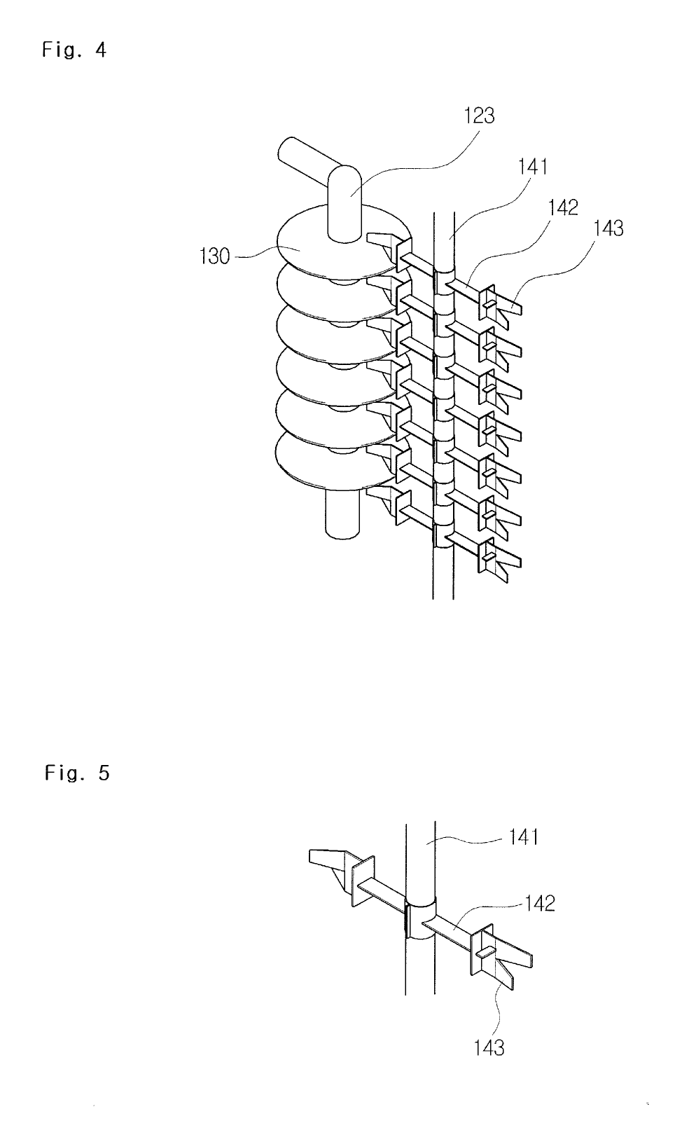

As shown in FIGS. 1 to 5, a sludge drying system according to an exemplary embodiment of the present invention includes a preprocessing part 10, a drying part 20, and a post-processing part 80.

The preprocessing part 10 is to preprocess sludge after mixing the sludge with transfer oil, and includes a sludge supplying part 11, a transfer oil storage tank 12 for storing the transfer oil, a recoverable oil storage tank 13 for recovering and storing transfer oil separated from the sludge, and a preheating and mixing tank 14.

The sludge supplying part 11 collects and provides sludge generated in houses, food manufacturers, sewage treatment plants, water treatment plants, industrial sites, and others.

Here, the sludge means livestock wastewater sludge generated in stockbreeding farmhouses and food sludge generated in houses and restaurants as well as paper sludge and leather and waste water sludge.

Moreover, the transfer oil is one of C-heavy oil, abandoned edible oil, animal and vegetable oils, and fish oil.

The preheating and mixing tank 14 mixes and preheats the transfer oil and the sludge supplied from the sludge supplying part 11, the recoverable oil storage tank 13 and the transfer oil storage tank 12 so as to dry the sludge in advance and to increase fluidity of the sludge.

Here, the preheating and mixing tank 14 preheats the sludge mixed with the transfer oil at temperature of 70° C. to 90° C. for about 10 minutes to 20 minutes. After that, the sludge and the transfer oil are mixed together in the preheating and mixing tank 14, such that the sludge drying system can evaporate moisture of the sludge to the maximum and increase the quantity of heat. That is, the preheating and mixing tank 14 preheats and mixes the sludge and the transfer oil into a sludge type to dry a great deal of moisture contained in the transfer oil and the sludge within a short period of time so as to enable an effective drying.

Meanwhile, the transfer oil mixed in the preheating and mixing tank 14 is mixed at a ratio of 50% of the gross weight of the sludge.

In other words, it is preferable that the sludge and the transfer oil be mixed in the preheating and mixing tank 14 at the ratio of 50:50 and be preheated at temperature of 80° C. for 10 minutes to 20 minutes.

The drying part 20 dries the preprocessed sludge, namely, the sludge which is mixed with the transfer oil and preheated, in a vacuum state in a multi-stepwise manner.

Here, the drying part 20 varies drying temperature of the sludge and the width of a change in moisture-content of the sludge in proportion to the number of steps. That is, drying steps of the drying part 20 according to the exemplary embodiment of the present invention are varied according to conditions, and hence, drying temperature and moisture-content of the sludge can be regulated by each drying step.

The drying part 20 includes: a first drying part 30 for firstly drying the preheated and preprocessed sludge at temperature of 75° C. to 95° C.; a second drying part 40 for secondly drying the firstly dried sludge at temperature of 80° C. to 90° C.; a third drying part 50 for thirdly drying the secondly dried sludge at temperature of 85° C. to 95° C.; a fourth drying part 60 for fourthly drying the thirdly dried sludge at temperature of 90° C. to 95° C.; and a controlling part 70 for stabilizing the fourthly dried sludge.

The first, second, third and fourth drying parts 30, 40, 50 and 60 respectively include: first, second, third and fourth vacuum drying pipes 31, 41, 51 and 61 for depressurizing the supplied sludge into a vacuum state; first, second, third and fourth liquid-vapor separators 32, 42, 52 and 62 for separating moisture and gas discharged from the first, second, third and fourth vacuum drying pipes 31, 41, 51 and 61; and first, second, third and fourth condensers 33, 43, 53 and 63 for condensing the separated moisture and gas.

Here, the first, second, third and fourth vacuum drying pipes 31, 41, 51 and 61 respectively evaporate and heat the sludge for about 20 minutes to 40 minutes, and then, the sludge is dried to moisture content of about 0.1%. Additionally, moisture and gas discharged from the first, second, third and fourth vacuum drying pipes 31, 41, 51 and 61 are separated by the first, second, third and fourth liquid-vapor separators 32, 42, 52 and 62, and then, are condensed by the first, second, third and fourth condensers 33, 43, 53 and 63. The structures of the first, second, third and fourth vacuum drying pipes 31, 41, 51 and 61 will be described in detail later.

The controlling part 70 stirs and heats the sludge in order to softly stabilize the sludge before the sludge dried to the moisture content within a range of about 2% after passing through the drying part 20.

The controlling part 70 includes: first and second vacuum drying control pipes 71a and 71b for separately receiving the sludge discharged from the fourth vacuum drying pipe and drying the received sludge in the vacuum state while stirring the sludge; fifth and sixth liquid-vapor separators 72a and 72b for separating moisture and gas discharged from the first and second vacuum drying control pipes 71a and 71b; and fifth and sixth condensers 73a and 73b for condensing the separated moisture and gas.

The first and second vacuum drying control pipes 71a and 71b respectively receive some steam and stir the sludge while heating the sludge at temperature of about 125° C. for 10 minutes. Moreover, moisture and gas discharged from the first and second vacuum drying control pipes 71a and 71b are separated from each other by the fifth and sixth liquid-vapor separators 72a and 72b, and then, condensed by the fifth and sixth condensers 73a and 73b.

Meanwhile, gas generated from the first, second, third and fourth vacuum drying pipes 31, 41, 51 and 61 and the first and second vacuum drying control pipes 71a and 71b through the first to sixth condensers 33, 43, 53, 63, 73a and 73b is supplied to a fuel consumer, such as a boiler, through a vacuum pump so as to be used as a steam heat carrier, and condensate water is treated in a water treatment plan through an oil-water separator.

The post-processing part 80 separates and treats the transfer oil from the sludge dried through the drying part 20.

The post-processing part 80 includes: a feeding tank for collecting and supplying the sludge dried through the drying part 20; a centrifugal oil extractor 82 for separating the transfer oil from the sludge supplied from the feeding tank 81 by a centrifugal force of 1000G to 2000G; and a dried sludge storage tank 83 for storing the dried sludge from which the transfer oil is separated.

Here, the dried sludge stored in the dried sludge storage tank 83 is pulverized or solidified, namely, fuelized, so as to be supplied as fuel for fuel consumers.

The transfer oil separated from the dried sludge by the centrifugal oil extractor 82 is transferred to the recoverable oil storage tank 13 and provided to the preheating and mixing tank 14 so as to be reused. Furthermore, a bucket conveyer 84 is disposed between the centrifugal oil extractor 82 and the dried sludge storage tank 83 so as to transfer the sludge, nitrogen is supplied to the bucket conveyer 84 and the dried sludge storage tank 83 so as to promote stabilization of fuel.

The first, second, third and fourth vacuum drying pipes 31, 41, 51 and 61 have the same structure, and are called a vacuum drying pipe 100 convenience's sake.

The vacuum drying pipe 100 is hollow, and includes: a body 110 having a space for receiving and drying moisture-containing sludge from the outside; a vacuum exhaust port 111 for exhausting the inside air when vapor pressure is generated over a preset atmospheric pressure; a sludge inlet 112 for receiving sludge; a sludge outlet 113 for discharging dried sludge; and a condensate water outlet 114 for discharging out condensate water generated by steam heat.

A steam chamber 120 is disposed below the body 110. The steam chamber 120 includes a steam supply port 121 for supplying steam and a steam recovering port 122 for recovering steam.

In addition, a stirring shaft 141 which is rotatably connected with a motor is vertically mounted at the center of the body 110, stirring wings 142 are mounted on the stirring shaft 141 at regular intervals, and stirring blades 143 which are respectively formed in the letter “V” are mounted at ends of the stirring wings 142.

A plurality of heating plates 130 are mounted on the inner circumferential surface of the body 110 at predetermined intervals in such a manner that the stirring wings 143 can pass between the heating plates 130.

A steam pipe 123 passes through the center of the heating plates 130 so as to supply steam to the inside of the heating plates 130. A lower portion of the steam pipe 123 is fixed to the body 110 and communicates with the steam chamber 120, and an upper portion of the steam pipe 123 is connected to the steam supply port 121.

It is preferable that the heating plates 130 be inclined toward the center of the body 110. Because the heating plates 130 are inclined, the dried sludge can smoothly slide on the heating plates 130 using the gravity drop.

The vacuum drying pipe 100 according to the exemplary embodiment of the present invention stirs the sludge while rotating the stirring wings 142 when the motor is driven after the sludge and the transfer oil are mixed and put into the sludge inlet 112.

At the same time, when steam is supplied through the steam supplying part 121, steam is supplied to the steam pipe 123, the heating plates 130 and the steam chamber 120, such that the sludge is heated and dried, and in this instance, steam is recovered and recycled through the steam recovering port 122.

Condensate water generated while the sludge is heated is discharged out through the condensate water outlet 114, when vapor pressure is generated over the preset atmospheric pressure while the sludge is heated, the inside air is discharged out through the vacuum exhaust port 111.

As described above, the dried sludge is discharged out through the sludge outlet 113.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A sludge drying system comprising:
a preprocessing part including a sludge supplying part, a transfer oil storage tank for storing transfer oil, a recoverable oil storage tank for recovering and storing transfer oil separated from the sludge, and a preheating and mixing tank;
a drying part including a first drying part, a second drying part, a third drying part, a fourth drying part and a controlling part which are divided in a multi-stepwise manner, the first, second, third and fourth drying parts respectively including: first, second, third and fourth vacuum drying pipes for depressurizing the supplied sludge into a vacuum state; first, second, third and fourth liquid-vapor separators for separating moisture and gas discharged from the first, second, third and fourth vacuum drying pipes; and first, second, third and fourth condensers for condensing the separated moisture and gas, the controlling part including: first and second vacuum drying control pipes for receiving the sludge discharged from the first, second, third and fourth vacuum drying pipes and drying the received sludge in the vacuum state while stirring the sludge; fifth and sixth liquid-vapor separators for separating moisture and gas discharged from the first and second vacuum drying control pipes; and fifth and sixth condensers for condensing the separated moisture and gas; and
a post-processing part including a feeding tank for collecting and supplying the sludge dried through the drying part; a centrifugal oil extractor for separating the transfer oil from the sludge supplied from the feeding tank by a centrifugal force; and a dried sludge storage tank for storing the dried sludge from which the transfer oil is separated.

2. The sludge drying system according to claim 1, wherein the sludge and the transfer oil are mixed in the preheating and mixing tank at the ratio of 50:50 and are preheated at temperature of 80° C. for 10 minutes to 20 minutes.

3. The sludge drying system according to claim 1, wherein the first, second, third and fourth drying parts evaporate and heat the preheated sludge at temperature of 75° C. to 95° C. for 20 minutes to 40 minutes such that the sludge is dried at the moisture content of 2%.

4. The sludge drying system according to claim 1, wherein each of the vacuum drying pipes is hollow, and comprises:
a body having a space for receiving moisture-containing sludge from the outside and drying the received sludge, the body including: a vacuum exhaust port for exhausting the inside air when vapor pressure is generated over a preset atmospheric pressure; a sludge inlet for receiving sludge; a sludge outlet for discharging dried sludge; and a condensate water outlet for discharging out condensate water generated by steam heat;
a steam chamber disposed below the body, the steam chamber including a steam supply port for supplying steam and a steam recovering port for recovering steam;
a stirring shaft rotatably connected with a motor and vertically mounted at the center of the body;
stirring wings mounted on the stirring shaft at regular intervals;
stirring blades respectively formed in the letter “V” and mounted at ends of the stirring wings;
a plurality of heating plates mounted on the inner circumferential surface of the body at predetermined intervals in such a manner that the stirring wings can pass between the heating plates;
a steam pipe passing through the center of the heating plates so as to supply steam to the inside of the heating plates, wherein lower portion of the steam pipe is fixed to the body and communicates with the steam chamber and an upper portion of the steam pipe is connected to the steam supply port.

5. The sludge drying system according to claim 4, wherein the heating plates are inclined toward the center of the body.
